(19) United States
(12) Patent Application Publication
(10) Pub. No.: US 2002/0063864 A1
(43) Pub. Date: May 30, 2002

(54) Athermal mounting system

(76) Inventor: Jordan S. Honig, Arvada, CO (US)

Correspondence Address: Dean P. Edmundson, P.O. Box 710, Windsor, CO, 80550, US

(21) Appl. No.: 09/965,244

(22) Filed: Sep. 25, 2001

Related U.S. Application Data
(60) Provisional application No. 60/236,675, filed on Sep. 29, 2000.

(51) Int. Cl. G01J 3/00

(52) U.S. Cl. 356/326; 356/300

(57) ABSTRACT

A mounting assembly is described which includes first and second housings, a compressible member (e.g. an O-ring) positioned between the two housings, and metering screws for connecting the two housings such that the alignment of the two housings can be adjusted by rotation of the metering screws. Preferably, the O-ring has an elliptical cross-section.

### CROSS-REFERENCE TO RELATED APPLICATION

This application is based upon, and claims the benefit of, Provisional Application No. 60/236,675, filed Sep. 29, 2000.

### FIELD OF THE INVENTION

This invention relates to mounting systems. More particularly, this invention relates to mounting systems for optical components, e.g. for use in scientific instruments.

### BACKGROUND OF THE INVENTION

In scientific instruments (e.g. spectrometers) there are often components (e.g. optical components) which must be aligned and held in a secure position within a housing or mounting fixture of one type or another. To assure proper operation of the instrument, the optical components must be capable of focus adjustment and remain in proper alignment throughout a range of ambient temperatures.

There has not heretofore been provided an athermal mounting assembly having the features and advantages provided by the present invention.

### SUMMARY OF THE INVENTION

In accordance with the present invention there is provided a mounting assembly which effectively provides athermal alignment features for a plurality of components (e.g., optical components).

The mounting assembly, in a preferred embodiment, comprises:

(a) first housing means;

(b) second housing means;

(c) a compressible member positioned between the first and second housing means; and

(d) a plurality of metering screws adapted to connect the first and second housing means in a manner such that the alignment of the first and second housing means can be adjusted by rotation of the metering screws.

The mounting assembly enables optical components, for example, to be properly aligned with each other and to remain securely held in proper alignment even when the ambient temperature changes.

Other features and advantages of the mounting assembly of this invention will be apparent from the following detailed description and the accompanying drawings.

### BRIEF DESCRIPTION OF THE DRAWINGS

The invention is described in more detail hereafter with reference to the accompanying drawings, wherein like reference characters refer to the same parts throughout the several views and in which:

FIG. 1 is an exploded view of one embodiment of a mounting assembly of the invention;

FIG. 2 is a top plan view of one type of compressible member which is useful in the assembly of FIG. 1;

FIG. 3 is a cross-sectional view of the compressible member of FIG. 2 taken along line A-A; and

FIG. 4 is an enlarged sectional view of a portion of the compressible member shown in FIG. 3.

### DETAILED DESCRIPTION OF THE INVENTION

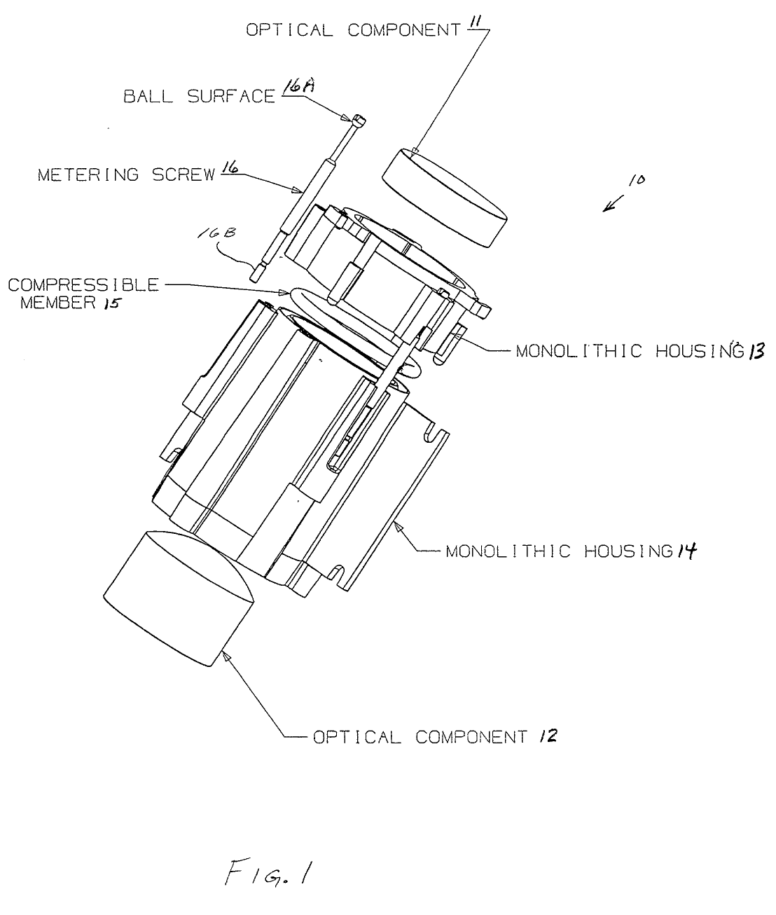

In FIG. 1 there is shown an exploded view of one embodiment of a mounting assembly 10 of the invention. This particular assembly is especially useful for the mounting of two optical components (e.g. a diffraction grating and a lens) for use in a scientific instrument (e.g. a spectrometer).

One optical component 11 is securely mounted in a first monolithic housing 13, and a second optical component 12 is securely mounted in a second monolithic housing 14. A compressible member 15 (e.g. an O-ring) is positioned between the abutting ends of the two housings.

Metering screws 16 are used to connect the two housing sections together. Preferably, there are three such metering screws which are equidistantly spaced around the periphery of the two housings. One end 16A of each screw preferably includes a ball surface which fits into a socket shaped boss in housing 13. The opposite end 16B is captured in housing 14.

The optical mounting assembly shown herein may be precisely aligned in pitch, yaw, and focus by means of the three metering or adjustment screws.

The positioning of the compressible member and the metering screws enables passive compensation for the thermal expansion of the optical components and their respective optical housings (without affecting the focal relationship of the two optical components) while still allowing for pitch, yaw and focus adjustment.

The use of separate monolithic housings for each optical component, separated by compressible members, enables use of molded or cast components without need for machine operations to create flexure features. This is a significant advantage.

Thus, the mounting assembly shown herein allows for three degrees of freedom in alignment and an athermalized function. The housing components which are joined together with a compressible member between them are sealed against stray light, dust and water intrusion by means of the compressible member(s).

This invention enables the optical components to be assembled and adjusted at the factory so that the ultimate user of the instrument does not have to make any adjustments of the alignment of the optical components. Also, the instrument has an improved operating temperature range.

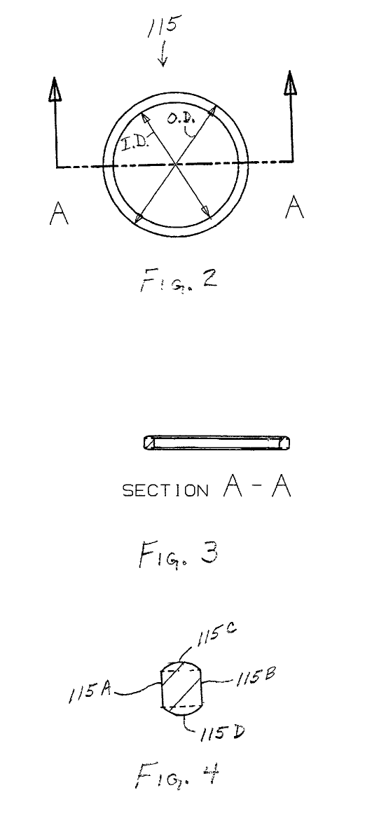

The present invention also provides an improved O-ring construction 115 which is shown in FIGS. 2-4. This O-ring has an elliptical or oval cross-section with flat sides, which is illustrated in FIGS. 3 and 4. The interior and exterior surfaces 115A and 115B are flat and are parallel to each other. The top and bottom surfaces 115C and 115D are convex. In one example of a suitable O-ring of this construction, the I.D. is 1.390 inches, the O.D. is 1.606 inches, the height is 0.147 inch, and the radius for the convex top and bottom surfaces is 0.074 inch. Other dimensions are also useful, depending the particular application for the O-ring.

The characteristics and advantages of this new O-ring construction are described hereafter.

### EXAMPLE

The objective in this example was to establish the relationship between applied torque to the metering screws and the amount of normal force required to create a similar amount of deflection on silicone O-rings. This information was pertinent to improving the focus mechanism of a spectrometer.

Two O-rings of similar height and different designs were used. Both were placed in a spectrometer housing of the type shown in FIG. 1, incrementally tightened with a torque wrench, and then measured for changes in height after each adjustment.

Similarly, by incrementally loading known weights on an O-ring (using weighed amounts of lead shot), the amount of resultant compression can be measured.

Finally, by matching the measured deflection due to the different loading schemes, one can associate a weight (normal force) which will produce a comparable compressive change due to a torque screw load.

The data comparing the O-ring of circular cross-section with the O-ring of elliptical cross-section with flat sides is shown in the following tables. In practice, the O-ring of elliptical cross-section (FIG. 4) was observed to hold the spectrometer in proper focus with about 2 oz-inches of torque.

Table 1 highlights the difference in torque (2 oz-inches vs. 9 oz-inches) required for the assembler to get the spectrometer to the nominal focus position. The circular cross-section O-ring assemblies suffered from material creep, possibly due to the higher loading required to focus the instrument.

Table 2 summarizes tests to measure the amount of force (weight) required to compress the respective O-rings. The elliptical O-ring appears slightly more linear, with a 0.007 inch offset in height.

Table 3 collates the relationship between torque applied to focus the spectrometer a given amount and the force required to deflect the O-ring that same distance.

The data indicates a more linear relationship between applied torque and O-ring deflection using the elliptical cross-section. The elliptical O-ring locates the spectrometer at the nominal starting point with less adjustment of the metering screws. The reduced compression should lower the risk of distorting the mating parts of the housing. The lower torque requirements may also eliminate hysteresis problems encountered during thermal cycling.

The term “elliptical” as used herein is intended to cover not only cross-sections which are ellipses but also those which are oval or elongated round shapes.

TABLE 1
Torque vs. Compression

| | APPIIED TORQUE | | | NOMINAL BOSS GAP* | | | | | | | | |
|---|---|---|---|---|---|---|---|---|---|---|---|---|
| OZ-INCHES* | 1 oz in | 1.5 oz in | 2 oz in | 2.5 oz in | 3 oz in | 3.5 oz in | 4 oz in | 4.5 oz in | 5 oz in | 6 oz in | 7 oz in | 9 oz in |

elliptical o-ring

| | | | | | | | | | | | | |
|---|---|---|---|---|---|---|---|---|---|---|---|---|
| LUG #1 | 3.283 | 3.278 | 3.276 | 3.273 | 3.273 | 3.272 | 3.268 | 3.267 | 3.267 | 3.26 | 3.264 | 3.262 |
| LUG#2 | 3.274 | 3.268 | 3.267 | 3.268 | 3.265 | 3.263 | 3.263 | 3.261 | 3.261 | 3.258 | 3.257 | 3.254 |
| LUG #3 | 3.287 | 3.278 | 3.278 | 3.275 | 3.272 | 3.268 | 3.266 | 3.264 | 3.262 | 3.261 | 3.259 | 3.257 |
| AVE | 3.281 | 3.275 | 3.274 | 3.272 | 3.270 | 3.268 | 3.266 | 3.264 | 3.263 | 3.260 | 3.260 | 3.258 |
| Δ HEIGHT | 0.000 | 0.007 | 0.008 | 0.009 | 0.011 | 0.014 | 0.016 | 0.017 | 0.018 | 0.022 | 0.021 | 0.024 |
| round o-ring | | | | | | | | | | | * | |
| LUG #1 | 3.316 | 3.309 | 3.305 | 3.308 | 3.299 | 3.295 | 3.289 | 3.286 | 3.284 | 3.279 | 3.279 | 3.276 |
| LUG#2 | 3.320 | 3.317 | 3.312 | 3.312 | 3.312 | 3.309 | 3.308 | 3.306 | 3.297 | 3.289 | 3.284 | 3.278 |
| LUG #3 | 3.319 | 3.311 | 3.309 | 3.308 | 3.305 | 3.304 | 3.299 | 3.298 | 3.296 | 3.292 | 3.288 | 3.285 |
| AVE | 3.318 | 3.312 | 3.309 | 3.309 | 3.305 | 3.303 | 3.299 | 3.297 | 3.292 | 3.287 | 3.284 | 3.280 |
| Δ HEIGHT | 0.000 | 0.006 | 0.010 | 0.009 | 0.013 | 0.016 | 0.020 | 0.022 | 0.026 | 0.032 | 0.035 | 0.039 |

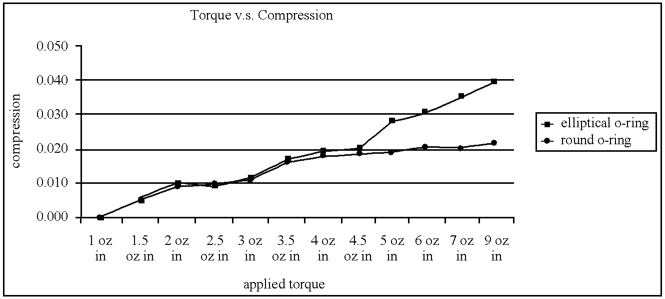 TABLE 2
Force vs. Compression
ORING SHAPE

| design per | net force | 3lbf | 6lbf | 9lbf | 12lbf | 15lbf | 18lbf | 21lbf | 25lbf | 28lbf |
|---|---|---|---|---|---|---|---|---|---|---|
| | per corner | .75 lbf | 1.5 lbf | 2.25 lbf | 3 lbf | 3.75 lbf | 4.5 lbf | 5.25 lbf | 6.25 lbf | 7 lbf |
| ht (inches) | CORNER #1 | 0.633 | 0.630 | 0.628 | 0.625 | 0.625 | 0.621 | 0.622 | 0.620 | 0.625 |
| | CORNER#2 | 0.633 | 0.632 | 0.628 | 0.629 | 0.626 | 0.626 | 0.625 | 0.625 | 0.625 |
| | CORNER #3 | 0.637 | 0.635 | 0.635 | 0.635 | 0.633 | 0.635 | 0.632 | 0.630 | 0.624 |
| | CORNER#4 | 0.637 | 0.633 | 0.634 | 0.631 | 0.631 | 0.630 | 0.629 | 0.626 | 0.624 |
| | AVE | 0.635 | 0.633 | 0.631 | 0.630 | 0.629 | 0.628 | 0.627 | 0.625 | 0.625 |
| | Δ HEIGHT | 0.000 | 0.002 | 0.004 | 0.005 | 0.006 | 0.007 | 0.008 | 0.010 | 0.011 |
| round o-ring | | | | | | | | | | |
| | CORNER #1 | 0.64 | 0.639 | 0.636 | 0.637 | 0.635 | 0.634 | 0.633 | 0.628 | 0.624 |
| | CORNER#2 | 0.64 | 0.638 | 0.636 | 0.637 | 0.635 | 0.636 | 0.637 | 0.626 | 0.622 |
| | CORNER #3 | 0.643 | 0.641 | 0.641 | 0.639 | 0.638 | 0.639 | 0.637 | 0.637 | 0.639 |
| | CORNER#4 | 0.643 | 0.641 | 0.641 | 0.638 | 0.638 | 0.636 | 0.633 | 0.64 | 0.641 |
| | AVE | 0.642 | 0.640 | 0.639 | 0.638 | 0.637 | 0.636 | 0.635 | 0.633 | 0.632 |
| | Δ HEIGHT | 0.000 | 0.002 | 0.003 | 0.004 | 0.005 | 0.005 | 0.006 | 0.009 | 0.010 |

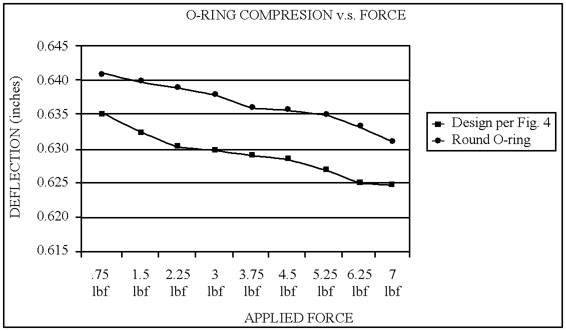 TABLE 3
TORQUE v.s. FORCE

| | ROUND PROFILE | | ELLIPTICAL PROFILE | |
|---|---|---|---|---|
| COMPRESSION | FORCE | TORQUE | FORCE | TORQUE |
| INCHES | LBF | OZ-IN | LBF | OZ-IN |
| 0.000 | 0.75 | 1.0 | 0.75 | 1.0 |
| 0.002 | 1.50 | | 1.50 | |
| 0.003 | 2.25 | | | |
| 0.004 | 3.00 | | 2.25 | |
| 0.005 | 3.75 | | | |
| 0.006 | 5.25 | 1.5 | 3.00 | |
| 0.007 | | | | 1.5 |
| 0.008 | | | 3.75 | 2.0 |
| 0.009 | 6.25 | 2.5 | | 2.5 |
| 0.010 | 7.00 | 2.0 | 4.50 | |
| 0.011 | | | | 3.0 |
| 0.012 | | | 5.25 | |
| 0.013 | | 3.0 | | |
| 0.014 | | | 6.25 | 3.5 |
| 0.016 | | 3.5 | 7.00 | 4.0 |
| 0.017 | | | | 4.5 |
| 0.018 | | | | 5.0 |
| 0.020 | | 4.0 | | 6.0 |
| 0.021 | | | | 7.0 |
| 0.022 | | 4.5 | | |
| 0.024 | | | | 9.0 |
| 0.026 | | 5.0 | | |
| 0.032 | | 6.0 | | |
| 0.035 | | 7.0 | | |
| 0.039 | | 9.0 | | |

What is claimed is:

1. A mounting assembly comprising:
(a) first housing means;
(b) second housing means;
(c) a compressible member positioned between said first and second housing means; and
(d) metering screws adapted to connect said first and second housing means in a manner such that the alignment of said first and second housing means can be adjusted by rotation of said metering screws.

2. A mounting assembly in accordance with claim 1, wherein said compressible member comprises an O-ring.

3. A mounting assembly in accordance with claim 2, wherein said O-ring has a circular cross-section.

4. A mounting assembly in accordance with claim 2, wherein said O-ring has an elliptical cross-section.

5. A mounting assembly in accordance with claim 4, wherein said O-ring has parallel opposing sides.

6. A mounting assembly in accordance with claim 1, wherein said first and second housing means are cylindrical.

7. A mounting assembly in accordance with claim 6, wherein there are three of said metering screws equidistantly spaced around said first and second housing means.

8. A mounting assembly in accordance with claim 1, wherein said first and second housing means comprise monolithic structures.

9. A compressible O-ring having an elliptical cross-section.
